(19) United States
(12) Patent Application Publication
(10) Pub. No.: US 2002/0120418 A1
(43) Pub. Date: Aug. 29, 2002

(54) Realtime deterministic product quality dispositioning system

(75) Inventor: Kevin Lee Johnson, Ariton, AL (US)

Correspondence Address: David E. Franklin, Wood, Herron & Evans, L.L.P., 2700 Carew Tower, 441 Vine Street, Cincinnati, OH, 45202-2917, US

(73) Assignee: Sony Corporation and Sony Electronics Inc.

(21) Appl. No.: 09/747,083

(22) Filed: Dec. 21, 2000

(51) Int. Cl. G06F 19/00; G01N 37/00; G06F 15/00; G06F 17/18; G06F 101/14

(52) U.S. Cl. 702/82

(57) ABSTRACT

An assembly line reliably produces articles assembled from at least two components by measuring critical dimensions of components destined to be assembled together as one particular article. A specified testable condition is predicted for the particular article by solving a regression equation previously ascertained from other assembled and tested articles having components with known critical dimensions. If the predicted testable condition is unsatisfactory, a rejection operation is performed so that any unacceptable article is prevented from being assembled or from being used.

### FIELD OF THE INVENTION

The present invention relates to automated assembly lines, and, more particularly, to assembly of articles from components having related critical dimensions.

### BACKGROUND OF THE INVENTION

Commercial products are often assembled from a number of components. Due to variations in manufacturing processes and techniques, each component tends to vary from the ideal dimensions. A defective article is produced when these variations exceed certain limits, preventing assembly altogether or reducing the reliability or functionality of the article.

Determining these dimensional limits is difficult. Variations in one component may mitigate, aggravate, or have no relationship with variations in other coupled components. It is often difficult to relate the dimensions of each component to the overall product requirements.

Conventional design practices include numerous approaches to accommodate variations in component dimensions, with problems associated with each approach. For example, arbitrarily small tolerances for each dimension of a component are chosen so that worst-case variations and combinations of variations result in an acceptable number of defects. Maintaining these tighter tolerances leads to increased costs by tending to require a more exacting and complex, and thus more expensive, manufacturing processes. Pre-screening of components is often used to achieve these tolerances.

As another example, assembled articles generally include a certain number of defective articles due to dimensional variances in components. These defective articles may fail after reaching a customer, thus incurring detrimental costs for repair or replacement. Alternatively, an additional step is added to the end of the assembly process to test each article, discarding or reworking the defective article or item.

As yet a further example, more complex assemblies are designed so that adjustments may be made during assembly. Also, additional touch labor is often used to ensure proper fit.

These approaches to component tolerances are poorly suited to assembly of consumer products assembled from economical molded plastic. Automated assembly lines are often supplied by hoppers filled with components from different manufacturing lots and even different suppliers. Strict inventory inspection and segregation is not practical or desirable. Additional testing after assembly is required due to these variations. Consequently, a significant need exists for reducing or eliminating the need for post-assembly testing.

### SUMMARY OF THE INVENTION

The present invention addresses these problems and other problems in the prior art with a dispositioning system and method that predicts whether an article will be defective by measuring critical dimensions of components selected for assembly into the article, and solving a regression equation with these measured critical dimensions. A rejection command is produced in response to a prediction that is not acceptable.

Thus, applications consistent with the invention allow greater tolerances in component dimensions yet avoid pre-screening of components upon receipt and testing of articles after assembly. These and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention. The features and advantages of the present invention will become more clearly appreciated from the following description taken in conjunction with the accompanying drawings in which like elements are denoted by like reference numerals.

FIG. 1 is a block diagram of an assembly line incorporating a dispositioning system.

FIG. 2 is a plot of extraction forces for a designed regression equation experiment.

FIG. 3 is a flow diagram for dispositioning articles or components of articles based on pre-assembled component measurements.

### DETAILED DESCRIPTION OF THE DRAWINGS

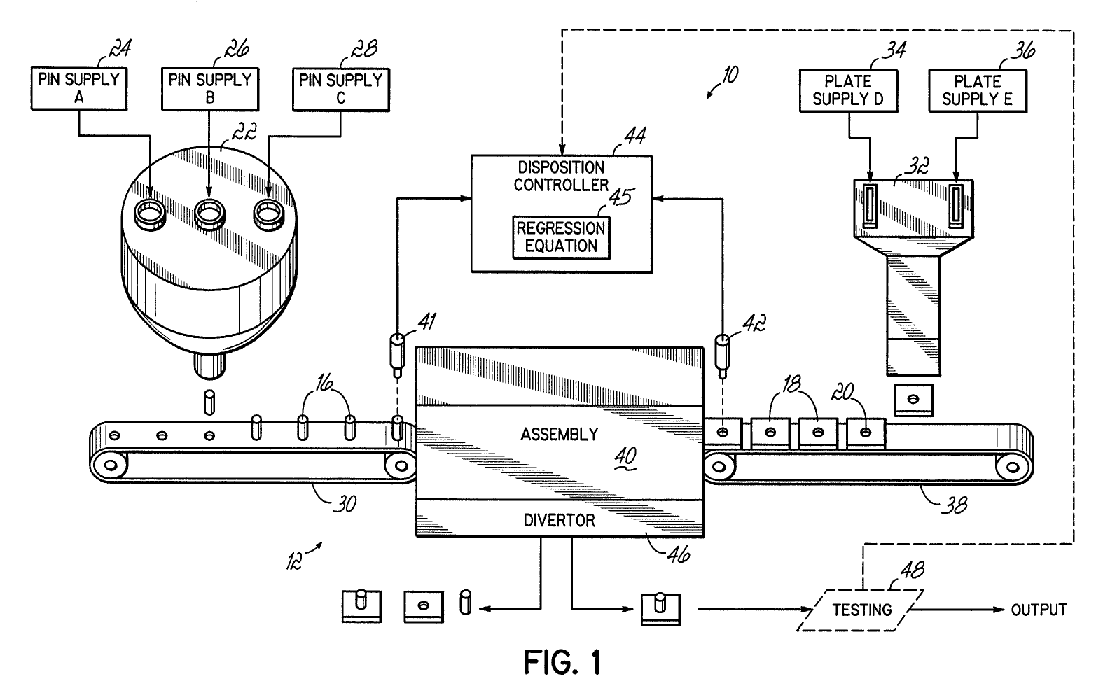

With reference to FIG. 1, a dispositioning system 10 is incorporated into an assembly line 12 that assembles articles 14 from a first component, such as a molded plastic pin 16, and a second component, such as a plastic plate 18 having a pin hole 20. An outer diameter of the pin 16 forms an interference fit with an inner diameter of the pin hole 20.

The specific dimensions of a selected pin 16 and selected hole 20 significantly interact in defining the amount of force required to insert or to retract the pin 16. A range of retraction force defines an acceptance criteria for the assembled article 14. The corresponding rejection criteria includes a force range below the acceptance criteria. The lower force range indicates a likelihood of a pin 16 to inadvertently fall out of a hole 18. The rejection criteria also includes a higher force range than the acceptance criteria. The higher force range is unacceptable due to limits on the assembly line 12 or the pin 16 and plate 18 to withstand the increased force during insertion.

The pins 16 for the assembly line 12 are stored in a pin hopper 22. The pin hopper 22 in turn is intermittently supplied from pin supply A 24, pin supply B 26, and pin supply C 28. Having a number of suppliers reduces schedule and cost risk, although variations in the dimensions of pins 16 are increased. The pin hopper 22 feeds pins 16 sequentially to a pin conveyor 30 for assembly.

The plates 18 for the assembly line 12 are stored in a plate hopper 32, also intermittently supplied from a plate supply D 34 and plate supply E 36. The plate hopper feeds plates 18 sequentially to a plate conveyor 38 for assembly. An assembly device 40 inserts each pin 16 from the pin conveyor 30 into a respective hole 20 of a plate 18 from the plate conveyor 38 in order to produce an assembled article 14 for being output from the assembly line 12.

The dispositioning system 10 advantageously dispositions articles 14 with a pin sensor 41, such as a laser micrometer, a plate hole sensor 42, such as a laser micrometer, a disposition controller 44, and a divertor 46. Each sensor 41, 42 senses a parameter of the component to be assembled that relates to a testable condition of the ultimately assembled article 14. In the illustrative embodiment, the parameters are respectively a linear dimension across an outer and inner diameter of each pin 16 and hole 20. The significant interaction of these dimensions relates to the testable condition of retraction force of removing a pin 16 from a hole 20 after assembly.

These sensed parameters are received by a disposition controller 44 that is configured to solve a regression equation 45 dependent upon the parameters to predict the testable condition of an article 14. The disposition controlled 44 is further configured to compare each assembled article prediction to an acceptance criteria, or inversely a rejection criteria.

If the prediction is outside of the acceptance criteria (i.e., satisfies the rejection criteria), the disposition controller produces a rejection command to the divertor 46 for performing a rejection operation. This rejection operation is a selected one or more of discarding or segregating a pin 16, plate 18, or assembled article 14.

TABLE 1

| | Data Set 1 | Data Set 2 | Data Set 3 | Data Set 4 |
|---|---|---|---|---|
| Mean Pin | 2.8 | 2.8 | 2.9 | 2.9 |
| Diameter | | | | |
| (Factor A) | | | | |
| Mean Hole | 2.8 | 2.9 | 2.8 | 2.9 |
| Diameter | | | | |
| (Factor B) | | | | |
| | Extraction Force | | | |
| Y1 | 140.1122680 | 9.938340807 | 2000.525814 | 140.1122680 |
| Y2 | 141.6684953 | 10.65197128 | 1999.330998 | 141.6684953 |
| Y3 | 140.6255163 | 9.155061232 | 2000.362877 | 140.6255163 |
| Y4 | 139.3934432 | 10.29799139 | 1999.518307 | 139.3934432 |
| Y5 | 140.8950906 | 10.90012691 | 1999.596535 | 140.8950906 |
| Y6 | 140.8409017 | 11.39616986 | 2001.17652 | 140.8409017 |
| Y7 | 139.3604683 | 10.98916871 | 2000.260052 | 139.3604683 |
| Y8 | 139.6412862 | 11.38590167 | 1999.586639 | 139.6412862 |
| Y9 | 141.3605677 | 8.704463451 | 1999.176725 | 141.3605677 |

One example of development of a regression equation is a two-factor, two-level full factorial designed experiment, illustrated in part in Table 1. In particular, each of four data sets was created with a specific mean value for pin diameter (factor A) and hole diameter (factor B). Specific components are dimensionally measured and assembled. Then, the extraction force is measured as shown on Table 1. The resulting extraction force data was processed by a statistical analysis program, DOE KISS available from Air Academy Associates. The resulting regression equation was Extraction Force=−1404182.6401+502844.4870A+482948.8034B−172946.1913AB, where A is pin diameter, B is the hole diameter, and AB is the interaction effect. This equation may be applied to components to predict the extraction force.

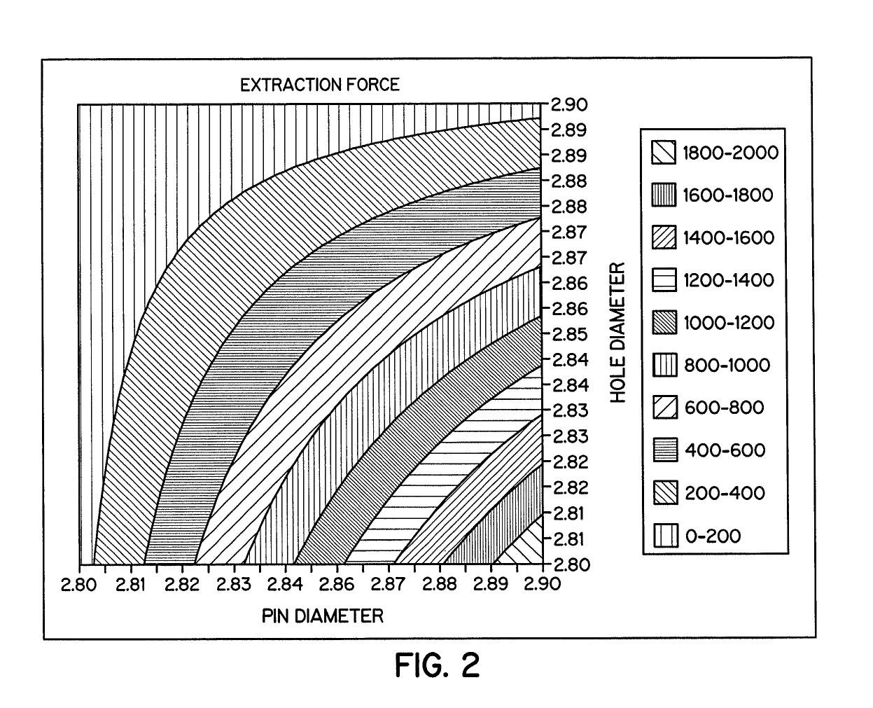

Referring to FIG. 2, a plot of the measured extraction forces shows a graphical approach to depicting the extraction force prediction. In FIG. 2, the pin diameters and hole diameters used in the development of the regression equation are plotted against the measured extraction force.

Development of the regression equation 46 generally occurs before full production of assembled articles 14, although periodic updates may be performed thereafter. In particular, components with known parameters are used in a designed experiment to cover the range of variances/tolerances of these components. The assembled articles 14 then undergo a testing operation 48 that is typically not used during full production. The results of the testing operation 48 allow identification of significant interactions as well as a model of the predicted testable conditions due to the tested outcomes and their frequency, as such regression equations are known to those skilled in the art. The disposition controller 44 accesses the regression equation data from the testing operation 48.

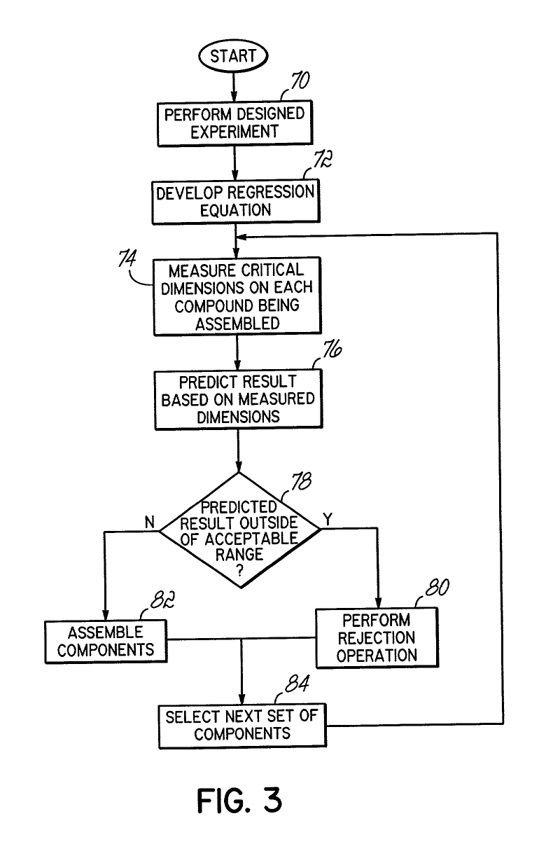

A procedure 60 of predictive use of a regression equation to disposition assembled articles is depicted in FIG. 3. In particular, a designed experiment is performed (Block 70). The results of the designed experiment allow the development of a regression equation (Block 72) for use during production.

During production, critical dimensions of each component being assembled are measured (Block 74). A prediction for the article being assembled is made based on the measured dimensions for the components destined for this article (Block 76). Then, the prediction is compared to acceptance criteria (e.g., is the predicted result outside of an acceptance range) (Block 78). If unacceptable, a rejection operation is performed (Block 80). Otherwise, if acceptable in Block 78, then the components are assembled into an article (Block 82). Then the next set of components are selected for assembly (Block 84), and processing of components and articles returns to Block 74 for repeating the procedure 60.

While the present invention has been illustrated by the description of embodiments thereof, and while the embodiments have been described in considerable detail, it is not intended to restrict or in any way limit the scope of the appended claims to such detail. Additional advantages and modifications will readily appear to those skilled in the art. The invention in its broader aspects is, therefore, not limited to the specific details, representative apparatus and method, and illustrative examples shown and described. Accordingly, departures may be made from such details without departing from the spirit or scope of the general inventive concept.

Having described the invention, what is claimed is:

1. A dispositioning control system comprising:
a sensor operable to sense a parameter of a first component on an assembly line; and
a controller configured to respond to the sensed parameter by solving a stored regression equation dependent upon the sensed parameter to obtain an assembled article prediction, the controller further configures to produce a rejection command in response to the prediction satisfying a rejection criteria.

2. The dispositioning control system of claim 1, wherein the sensed parameter is a linear dimension.

3. The dispositioning control system of claim 1, further comprising:
a second sensor operable to sense a parameter of a second component that is assembled with the first component on the assembly line to form an assembled article;
wherein the controller is further configured to respond to the sensed parameter of the second component by solving the stored regression equation that is further dependent upon the sensed parameter of the second component.

4. The dispositioning control system of claim 3, wherein the sensed parameter by the first sensor corresponds to an outer dimension of the first component, and wherein the sensed parameter by the second sensor corresponds to an inner dimension of the second component, the assembled article prediction corresponding to an interference fit of the outer dimension of the first component within the inner dimension of the second component.

5. The dispositioning control system of claim 4, wherein the first component includes a pin having the outer dimension comprising an outer diameter, the second component including a recess having the inner dimension comprising an inner diameter, wherein the assembled article prediction comprises an extraction force for removing the pin from the recess.

6. The dispositioning control system of claim 2 further comprising a divertor responsive to the rejection command.

7. A dispositioning controller comprising:
a memory;
a program, resident in the memory, the program configured to respond to a sensed parameter of a component by solving a stored regression equation dependent upon the sensed parameter to obtain a processed component prediction, the program further responsive to an acceptance criteria compared to the processed component prediction to perform a rejection operation; and
a processor operable to execute the program.

8. A dispositioning controller program product comprising:
program configured to respond to a sensed parameter of a component by solving a stored regression equation dependent upon the sensed parameter to obtain a processed component prediction, the program further responsive to an acceptance criteria compared to the processed component prediction to perform a rejection operation; and
signal bearing medium containing the program.

9. A method for assembling an article, the method comprising:
accessing a regression equation for a testable condition of an article being assembled from a first component and a second component;
sensing a parameter of the first component related to the testable condition;
sensing a parameter of the second component related to the testable condition;
solving the regression equation to determine a predicted testable condition of the article; and
performing a rejection operation in response to the predicted testable condition satisfying a rejection criteria.

10. The method of claim 8, wherein accessing the regression equation further comprises:
determining the related parameter of the first component to the testable condition;
determining the related parameter of second component to the testable condition;
assembling a plurality of test articles from combinations of first and second components having known parameters;
measuring each test article for a respective testable condition; and
developing a regression equation based on the measured testable conditions as related to the respective known parameters.

11. The method of claim 8, wherein sensing the parameter of the first component comprises sensing an outer dimension of the first component, and wherein sensing the parameter of the second component comprises sensing as inner dimension of the second component, the testable condition corresponding to an interference fit of the outer dimension in the inner dimension.

12. The method of claim 10, wherein a selected one of sensing the outer dimension and sensing the inner dimension comprises performing a laser micrometer measurement.
